(19) United States
(12) Patent Application Publication
(10) Pub. No.: US 2016/0034717 A1
(43) Pub. Date: Feb. 4, 2016

(54) Filtering Transferred Media Content

(71) Applicant: International Business Machines Corporation, Armonk, NY (US)

(72) Inventors: Susann M. Keohane, Austin, TX (US); Gerald F. McBrearty, Austin, TX (US); Shawn P. Mullen, Buda, TX (US); Jessica C. Murillo, Round Rock, TX (US); Johnny M. Shieh, Austin, TX (US)

(21) Appl. No.: 14/447,261

(22) Filed: Jul. 30, 2014

(51) Int. Cl. G06F 21/62; H04L 29/08; H04L 29/06

(52) U.S. Cl. CPC G06F 21/6263; H04L 63/18; H04L 67/10

(57) ABSTRACT

An approach is provided in which an information handling system identifies areas of sensitive content in a digital image that is intended to be sent to a recipient. The information handling system retrieves rules corresponding to both the intended recipient and the sensitive content, and modifies the digital image based upon the identified rules. The modification of the digital image includes protecting the sensitive content, such as blurring a person's face on the digital image. In turn, the information handling system sends the modified digital image to the intended first recipient.

### BACKGROUND

With the dynamic interaction of smartphones with cameras, cloud storage, and social media, it is very difficult for a user to prevent accidental leaks of private information. For example, a user may accidentally post an image to a social media site that includes information that the user wishes to remain private, such as a picture of the user's children. Likewise, the user may send an image that includes private information to a partially trusted individual, such as a new co-worker, only for the co-worker to broadcast the image to other individuals or post the image on a social media site.

### BRIEF SUMMARY

According to one embodiment of the present disclosure, an approach is provided in which an information handling system identifies areas of sensitive content in a digital image that is intended to be sent to a recipient. The information handling system retrieves rules corresponding to both the intended recipient and the sensitive content, and modifies the digital image based upon the identified rules. The modification of the digital image includes protecting the sensitive content, such as blurring a person's face on the digital image. In turn, the information handling system sends the modified digital image to the intended first recipient.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is an exemplary diagram depicting an image capture device that modifies an image prior to transmitting the image based upon filtering rules that match the intended recipient and sensitive content detected in the image;

FIG. 2 is an exemplary diagram showing digital images that an image capture device modifies according to filtering rules corresponding to both an intended recipient and sensitive content included in the image;

FIG. 3 is an exemplary diagram showing rule creation windows for a user to create sensitive content filtering rules;

FIG. 4 is an exemplary diagram depicting a sensitive content filter rules table;

FIG. 5 is an exemplary diagram showing trust level assignment windows for which to assign a trust level to an intended recipient;

FIG. 6 is an exemplary flowchart depicting steps taken by an image capture device to modify digital images or digital image metadata according to filter rules prior to sending the digital image to a recipient;

FIG. 7 is a block diagram of a data processing system in which the methods described herein can be implemented; and

FIG. 8 provides an extension of the information handling system environment shown in FIG. 7 to illustrate that the methods described herein can be performed on a wide variety of information handling systems which operate in a networked environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

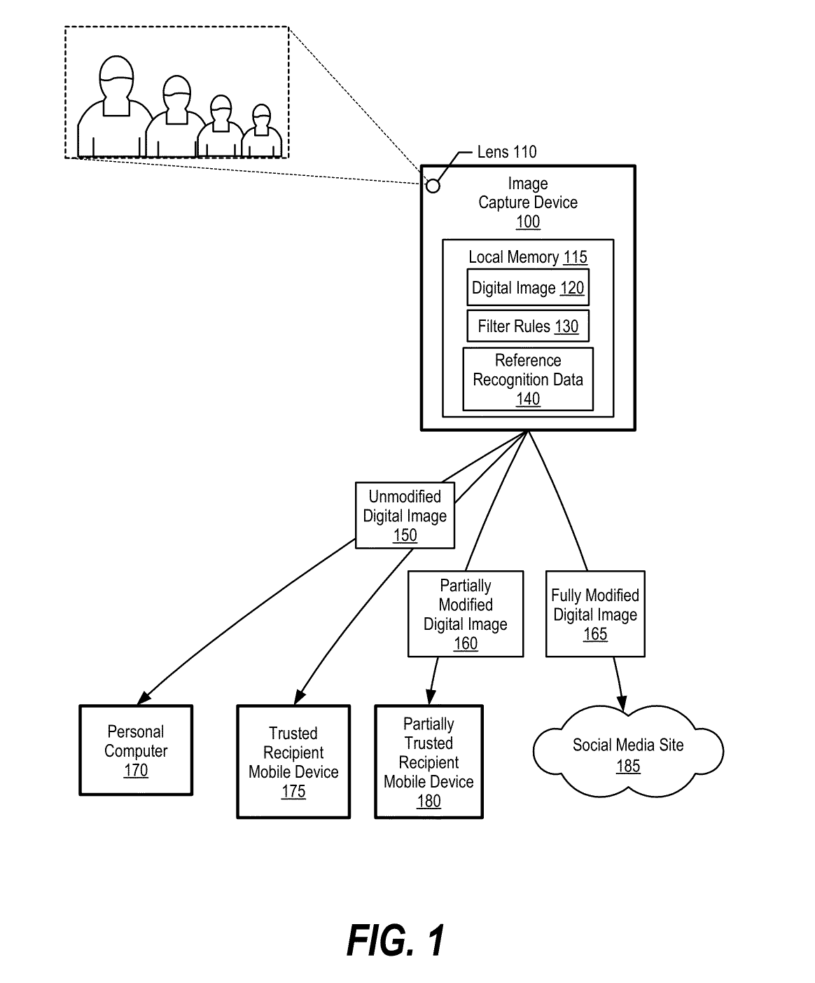

FIG. 1 is an exemplary diagram depicting an image capture device that modifies an image prior to transmitting the image based upon filtering rules matching the intended recipient and sensitive content included in the image. Image capture device 100 may be a smartphone, portable camera, tablet, laptop computer, or any other computing device that is capable of capturing an image and transmitting the image to a different computing device. Image capturing device 100 utilizes lens 110 to capture a digital image of four people, such as a family trip photo, which is stored in local memory as digital image 120. In one embodiment, image capture device 100 stores digital image metadata corresponding to digital image 120, which includes information pertaining to digital image 120, such as a time of day that the image is captured and the location of image capture device 100 when the image is captured.

When image capture device 100's user wishes to send the digital image to recipients such as family members, friends, or upload the digital image to social media sites, image capture device 100 determines, in one embodiment, whether the intended recipient is fully trusted, partially trusted, or not trusted. For example, family members may be fully trusted, co-workers may be partially trusted, and social media sites may be not trusted. In this embodiment, and as discussed in more detail below, image capture device 100 sends an unmodified digital image to fully trusted recipients.

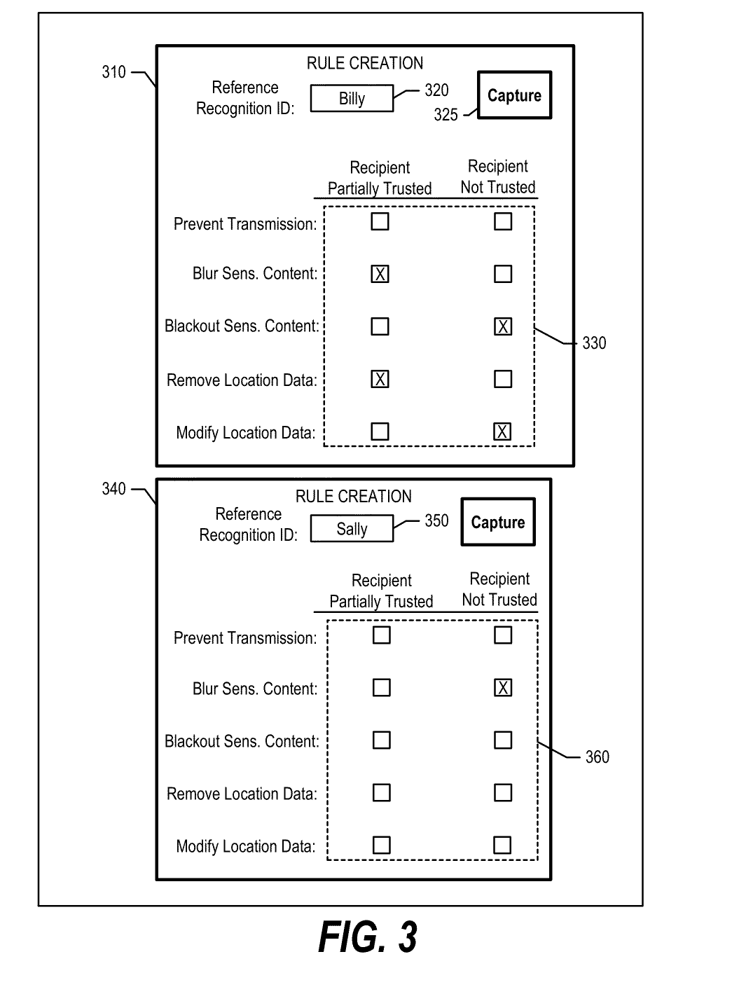

However, for partially trusted and not trusted recipients, image capture device 100 compares digital image 120 to reference recognition data 140 to determine whether digital image 120 includes sensitive content. In one embodiment, reference recognition data 140 includes facial recognition characteristics of people that the user wishes to filter based upon the intended recipient, such as the user's children (see FIG. 3 and corresponding text for further details).

When image capture device 100 determines that digital image 120 includes sensitive content (e.g., a picture of the user's child), image capture device 100 accesses filter rules 130 to locate rules pertaining to the intended recipient's trust level (e.g., partially trusted) and the identified sensitive content (e.g., “Billy”). In turn, image capture device 100 modifies digital image 120 based upon the located rules. For example, the rule may instruct image capture device 100 to blur Billy's face for images sent to partially trusted recipients. In one embodiment image capture device 120 also modifies digital image metadata, such as modifying or removing location information corresponding to digital image 120.

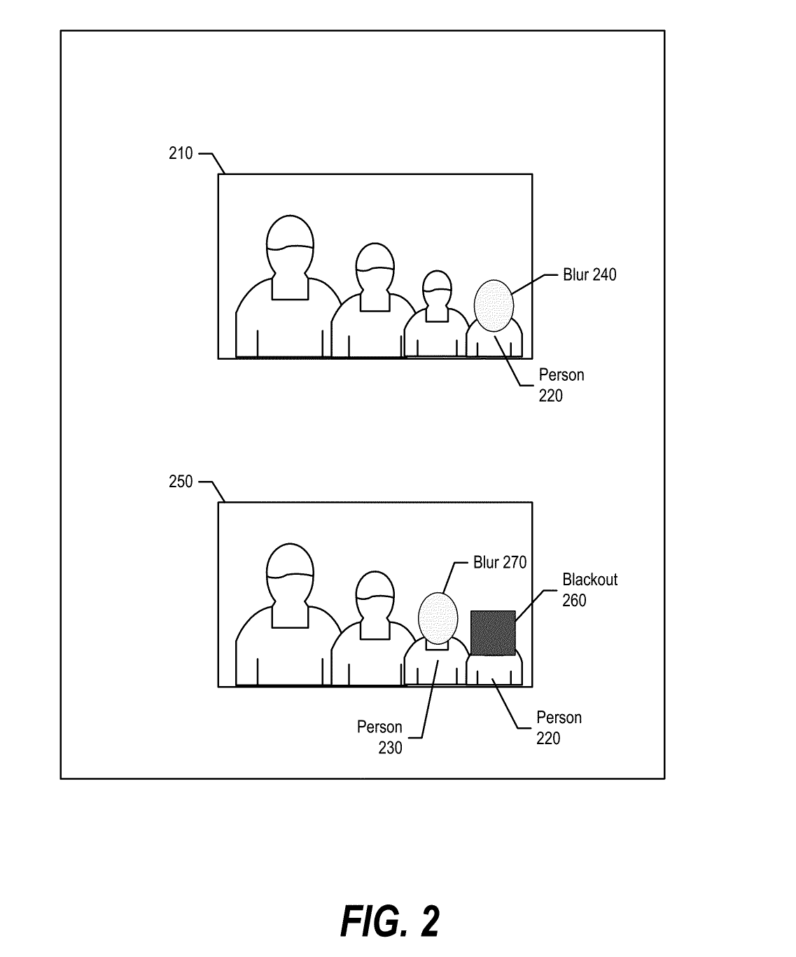

FIG. 1 shows an example of image capture device 100 sending an image to four different recipients. Personal computer 170 may belong to image capture device 100's user and, when the user connects image capture device 100 to personal computer 170, image capture device 100 downloads unmodified digital image 150 to personal computer 170 accordingly. Image capture device 100 also sends unmodified digital image 150 to mobile device 175, which belongs to a trusted recipient. However, image capture device 100 sends partially modified image 160 to mobile device 180, which belongs to a partially trusted recipient. For example, partially modified image 160 may include a blurred face of a child in the image (see FIG. 2 and corresponding text for further details).

Image capture device 100 uploads fully modified digital image 165 to social media site 185 that, in one embodiment, includes blacked out children's faces and removed location data. As such, a malicious user cannot obtain pertinent data from fully modified digital image 165 when the malicious user visits social media site 185. As those skilled in the art can appreciate, image capture device 100 may utilize more or less trust levels than those discussed above to refine the type of image modifications to perform on a digital image.

FIG. 2 is an exemplary diagram showing images that an image capture device modifies according to filtering rules corresponding to both an intended recipient and sensitive content included in the image. Modified image 210 (e.g., partially modified digital image) is an image that the image capture device blurred person 220's face via blur 240. For example, the recipient of modified image 210 may be a partially trusted co-worker and the image capture device's owner may have created a rule that blur's her adolescent child's face for any images sent to partially trusted recipients.

Similarly, modified image 250 (e.g., fully modified digital image) is an image that the image capture device blurred person 230's face via blur 270 and blacked out person 220's face via blackout 260. For example, the user may upload modified image 250 to an untrusted social media site and have a rule to blur her teenage child's face and blackout her adolescent child's face for images sent to untrusted recipients.

FIG. 3 is an exemplary diagram showing rule creation windows for a user to create sensitive content filtering rules. Window 310 allows a user to create a rule that instructs the image capture device to perform actions when the image capture device identifies sensitive content intended for a partially trusted recipient or untrusted recipient. A user enters a reference recognition identifier in box 320, such as “Billy.” The user then selects button 325 to capture a reference image of “Billy,” which the image capture device analyzes and generates reference recognition data of Billy. In one embodiment, the image capture device performs a facial recognition on the captured image and stores relevant facial characteristic data as the reference recognition data. In another embodiment, the image capture device provides the user with an option of selecting a previously captured image for the image capture device to analyze.

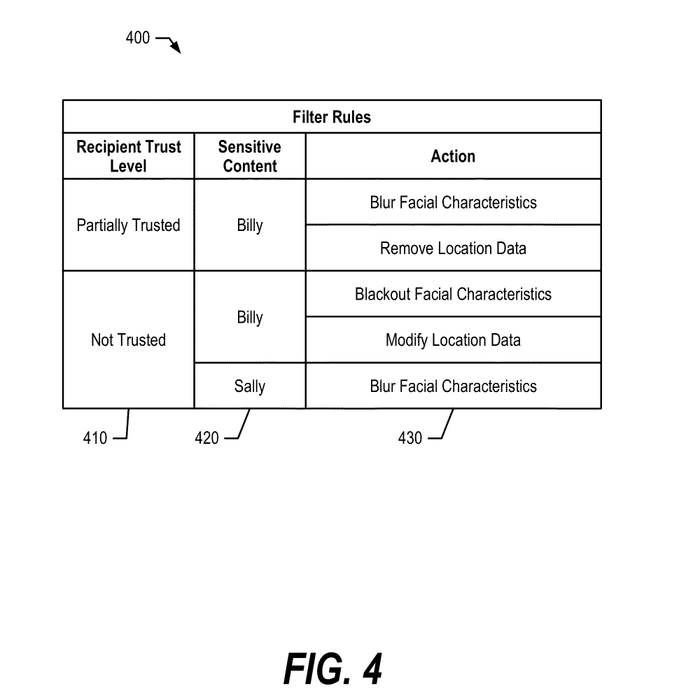

The user, in turn, selects one or more of boxes 330 to create rules for images that match the sensitive content based upon the trustworthiness of intended recipients. Boxes 330's selections cause image capture device to create a rule for partially trusted recipients (e.g., co-workers) that, when an image includes Billy's face, to blur out Billy's face and remove location data from the image's metadata. Similarly, the image capture device creates a rule for not trusted recipients (e.g., social media sites) that blacks out Billy's face and modifies location data from the image's metadata (see FIG. 4 and corresponding text for further details).

Window 340 shows a rule creation window for Sally (box 350). Boxes 360's selections cause image capture device to create a rule for not trusted recipients (e.g., social media sites) that blurs out Sally's face. In one embodiment, the image capture device performs the most stringent action on an image when an image includes sensitive content corresponding to multiple rules. For example, when an image intended for a not trusted recipient includes both Billy and Sally, the image capture device modifies the location data based upon Billy's rule even though Sally's rule does not specify modifying the location data.

FIG. 4 is an exemplary diagram depicting a sensitive content filter rules table. Table 400 includes various rules according to a recipient's trust level and sensitive content included in an image. Column 410 includes a list of trustworthiness levels, which are “partially trusted” and “not trusted.” The example in FIG. 4 does not include filter rules for trusted recipients, but the image capture device may create rules for trusted recipients as well.

Column 420 includes a list of sensitive content identifiers relative to a recipient's trust level. Column 420 shows that images of Billy are considered sensitive content for partially trusted recipients, and images of Billy and Sally are considered sensitive content for not trusted recipients.

Column 430 includes actions to perform on images having sensitive content corresponding to particular trust levels of intended recipients. For example, column 430 includes a rule to blur facial characteristics of Billy for images that the image capture device sends to partially trusted recipients.

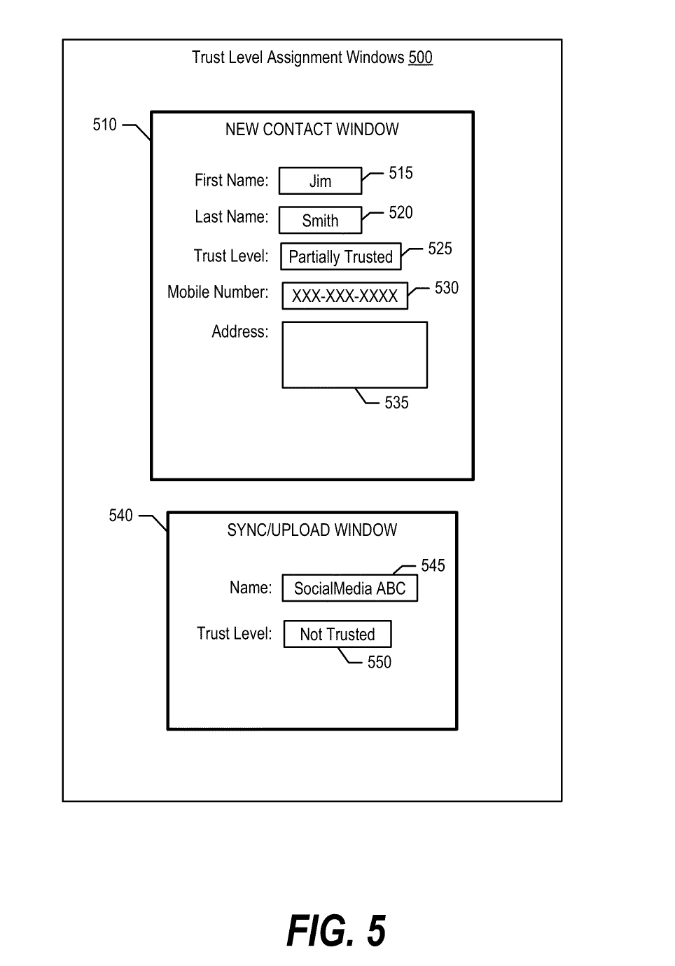

FIG. 5 is an exemplary diagram showing trust level assignment windows 500 for which to assign a trust level to a recipient. New contact window 510 allows a user to enter contact information and assign trust level to the new contact or existing contact. The user enters the contact's first name and last name in boxes 515 and 520, respectively, and enters the contact's trustworthiness in box 525. In one embodiment, box 525 is a drop down window that allows the user to select an available trust level. The user enters the contact's phone number and address in boxes 530 and 535, respectively.

Sync/Upload window 540 allows a user to assign a trust level to a location or device, such as cloud storage, social media site, or personal computer. Window 540 shows an example of the user creating a recipient entry for Social Media ABC, which includes the name (or URL) of the recipient in box 545 and the trustworthiness of the recipient in box 550. In one embodiment, as discussed above, box 550 is a drop down window that allows the user to select an available trust level for the recipient.

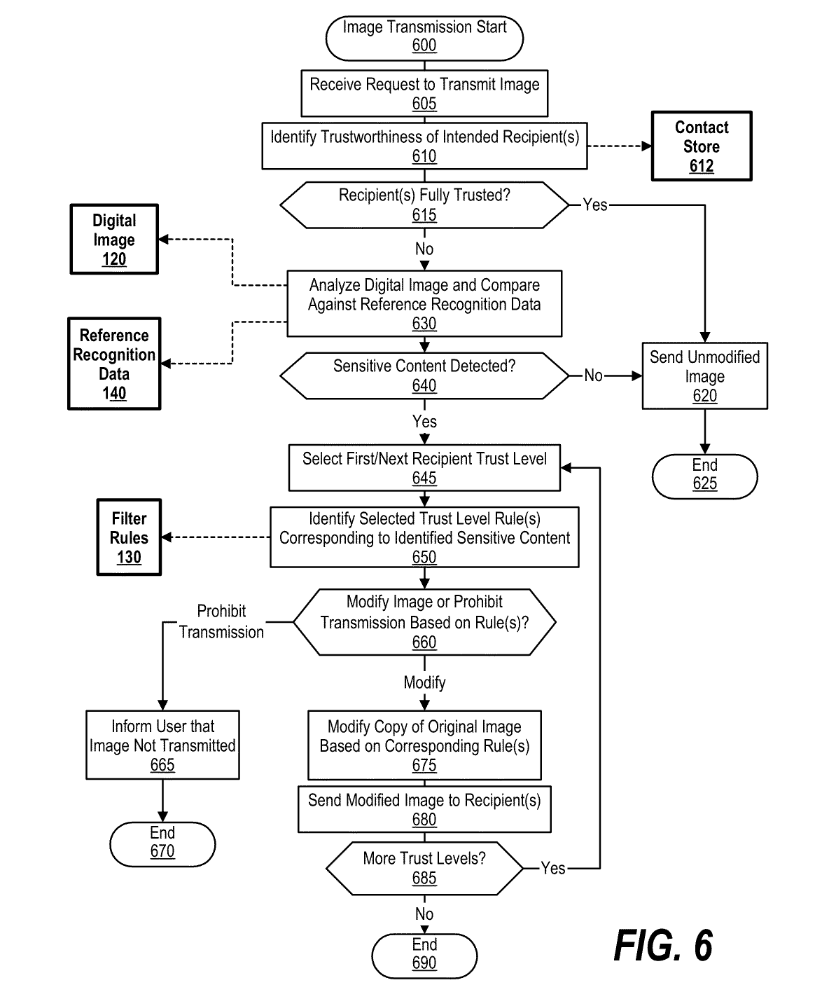

FIG. 6 is an exemplary flowchart depicting steps taken by an image capture device to modify a digital image or digital image metadata according to filter rules prior to sending the digital image to a recipient. Processing commences at 600, whereupon the image capture device receives a request from a user to transmit a captured image (digital image) (step 605) to a recipient or multiple recipients. For example, the user may take a picture of family members and wish to send the picture to a friend's mobile device. The image capture device identifies the trustworthiness of the intended recipients by accessing contact data included in contact store 612. For example, the user's friend may have a trust level of “partially trusted.”

The image capture device determines if any of the recipients are fully trusted and not associated with filter rules (decision 615). If any of the intended recipients are fully trusted, decision 615 branches to the “Yes” branch to send unmodified images to the fully trusted recipients at step 620, and processing ends at 625.

However, for those recipients not fully trusted, decision 615 branches to the “No” branch, whereupon the image capture device analyzes digital image 120 and compares the digital image against reference recognition data 140 (step 630). In one embodiment, the image capture device's analysis involves executing a facial recognition program to identify faces in the image and compare the identified faces with facial characteristic data included in reference recognition data 140.

The image capture device determines if the digital image includes sensitive content (decision 640). For example, the digital image may be of a mountain without people. If the digital image does not include sensitive content, decision 640 branches to the “No” branch, whereupon the image capture device sends the unmodified image to the partially trusted and not trusted recipients at step 620.

On the other hand, if the digital image includes sensitive content, decision 640 branches to the “Yes” branch, whereupon the image capture device selects a first trust level of the intended recipients (e.g., “Partially Trusted”) at step 645. At step 650, the image capture device identifies rules in filter rules 130 corresponding to both the selected trust level (e.g., “Partially Trusted) and the detected sensitive content (e.g., “Billy”). In one embodiment, if filter rules 130 does not include a rule matching the selected trust level and detected sensitive content, the image capture device sends an unmodified image to recipients corresponding to the selected trust level, which steps are not shown in FIG. 6 for simplicity purposes.

When filter rules 130 includes matching rules, the image capture device determines whether the matching rules dictate prohibiting transmission of the image (decision 660). If one of the identified rules dictate prohibiting image transmission, decision 660 branches to the “Prohibit Transmission” branch, whereupon the image capture device informs the user that the image is not transmitted (step 665) and, in one embodiment, a reason as to why the image is not transmitted (e.g., “Billy included in image and recipient is not trusted”). Processing ends at 670.

On the other hand, if the rule dictates modifying the image, decision 660 branches to the “Modify” branch, whereupon the image capture device modifies a copy of the digital image based upon the corresponding rules, such as blurring/blacking out a face (step 675). In one embodiment, the image capture device modifies digital image metadata, such as modifying/removing location data or time data. The image capture device sends the modified image to the recipient(s) corresponding to the selected trust level at step 680, and determines whether there are more intended recipients with a different trust level to process, such as “Not Trusted” (decision 685). If there are more intended recipients with different trust levels, decision 685 branches to the “Yes” branch, which loops back to select a different trust level and process images according to rules corresponding to the selected different trust level. This looping continues until there are no more trust levels to process, at which point decision 685 branches to the “No” branch, whereupon image capture device processing ends at 690.

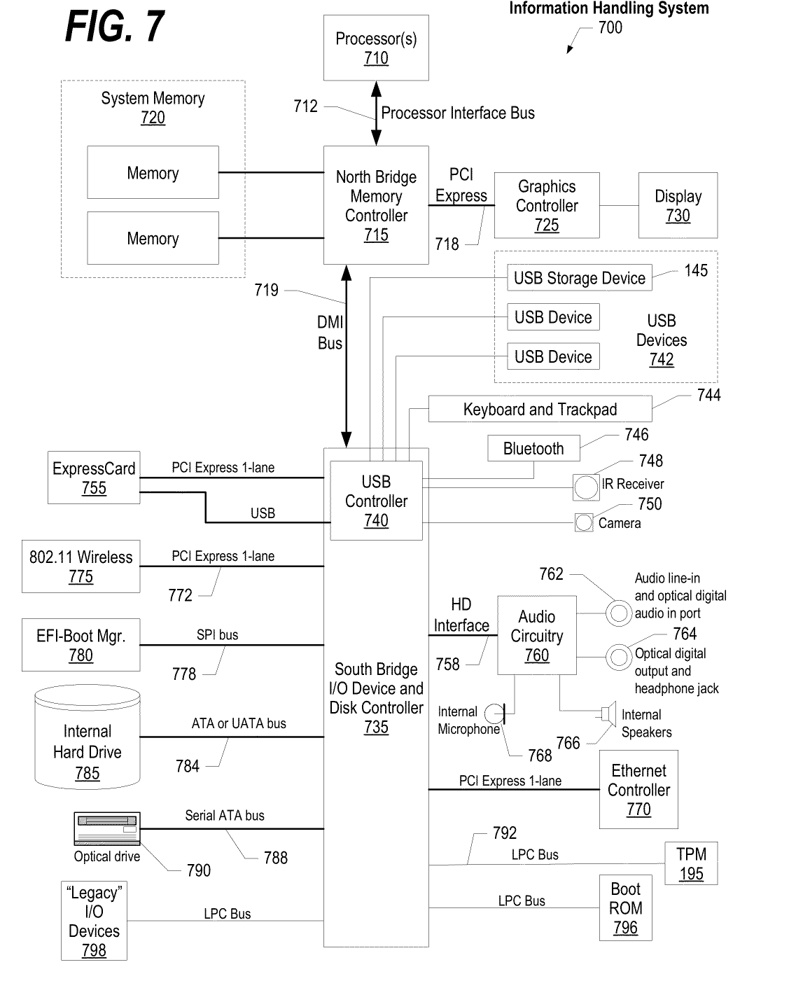

FIG. 7 illustrates information handling system 700, which is a simplified example of a computer system capable of performing the computing operations described herein. Information handling system 700 includes one or more processors 710 coupled to processor interface bus 712. Processor interface bus 712 connects processors 710 to Northbridge 715, which is also known as the Memory Controller Hub (MCH). Northbridge 715 connects to system memory 720 and provides a means for processor(s) 710 to access the system memory. Graphics controller 725 also connects to Northbridge 715. In one embodiment, PCI Express bus 718 connects Northbridge 715 to graphics controller 725. Graphics controller 725 connects to display device 730, such as a computer monitor.

Northbridge 715 and Southbridge 735 connect to each other using bus 719.

In one embodiment, the bus is a Direct Media Interface (DMI) bus that transfers data at high speeds in each direction between Northbridge 715 and Southbridge 735. In another embodiment, a Peripheral Component Interconnect (PCI) bus connects the Northbridge and the Southbridge. Southbridge 735, also known as the I/O Controller Hub (ICH) is a chip that generally implements capabilities that operate at slower speeds than the capabilities provided by the Northbridge. Southbridge 735 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 796 and “legacy” I/O devices (using a “super I/O” chip). The “legacy” I/O devices (798) can include, for example, serial and parallel ports, keyboard, mouse, and/or a floppy disk controller. The LPC bus also connects Southbridge 735 to Trusted Platform Module (TPM) 795. Other components often included in Southbridge 735 include a Direct Memory Access (DMA) controller, a Programmable Interrupt Controller (PIC), and a storage device controller, which connects Southbridge 735 to nonvolatile storage device 785, such as a hard disk drive, using bus 784.

ExpressCard 755 is a slot that connects hot-pluggable devices to the information handling system. ExpressCard 755 supports both PCI Express and USB connectivity as it connects to Southbridge 735 using both the Universal Serial Bus (USB) the PCI Express bus. Southbridge 735 includes USB Controller 740 that provides USB connectivity to devices that connect to the USB. These devices include webcam (camera) 750, infrared (IR) receiver 748, keyboard and trackpad 744, and Bluetooth device 746, which provides for wireless personal area networks (PANs). USB Controller 740 also provides USB connectivity to other miscellaneous USB connected devices 742, such as a mouse, removable nonvolatile storage device 745, modems, network cards, ISDN connectors, fax, printers, USB hubs, and many other types of USB connected devices. While removable nonvolatile storage device 745 is shown as a USB-connected device, removable nonvolatile storage device 745 could be connected using a different interface, such as a Firewire interface, etcetera.

Wireless Local Area Network (LAN) device 775 connects to Southbridge 735 via the PCI or PCI Express bus 772. LAN device 775 typically implements one of the IEEE 802.11 standards of over-the-air modulation techniques that all use the same protocol to wireless communicate between information handling system 700 and another computer system or device. Optical storage device 790 connects to Southbridge 735 using Serial ATA (SATA) bus 788. Serial ATA adapters and devices communicate over a high-speed serial link. The Serial ATA bus also connects Southbridge 735 to other forms of storage devices, such as hard disk drives. Audio circuitry 760, such as a sound card, connects to Southbridge 735 via bus 758. Audio circuitry 760 also provides functionality such as audio line-in and optical digital audio in port 762, optical digital output and headphone jack 764, internal speakers 766, and internal microphone 768. Ethernet controller 770 connects to Southbridge 735 using a bus, such as the PCI or PCI Express bus. Ethernet controller 770 connects information handling system 700 to a computer network, such as a Local Area Network (LAN), the Internet, and other public and private computer networks.

While FIG. 7 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

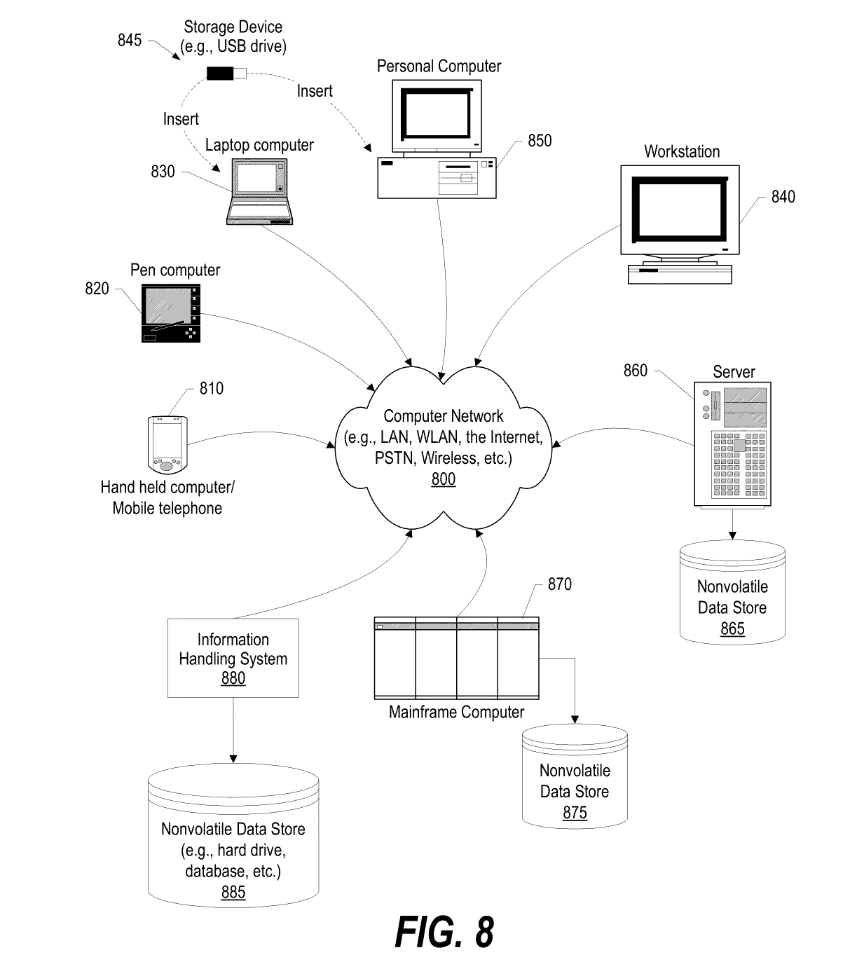

The Trusted Platform Module (TPM 795) shown in FIG. 7 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 8.

FIG. 8 provides an extension of the information handling system environment shown in FIG. 7 to illustrate that the methods described herein can be performed on a wide variety of information handling systems that operate in a networked environment. Types of information handling systems range from small handheld devices, such as handheld computer/mobile telephone 810 to large mainframe systems, such as mainframe computer 870. Examples of handheld computer 810 include personal digital assistants (PDAs), personal entertainment devices, such as MP3 players, portable televisions, and compact disc players. Other examples of information handling systems include pen, or tablet, computer 820, laptop, or notebook, computer 830, workstation 840, personal computer system 850, and server 860. Other types of information handling systems that are not individually shown in FIG. 8 are represented by information handling system 880. As shown, the various information handling systems can be networked together using computer network 800. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 8 depicts separate nonvolatile data stores (server 860 utilizes nonvolatile data store 865, mainframe computer 870 utilizes nonvolatile data store 875, and information handling system 880 utilizes nonvolatile data store 885). The nonvolatile data store can be a component that is external to the various information handling systems or can be internal to one of the information handling systems. In addition, removable nonvolatile storage device 745 can be shared among two or more information handling systems using various techniques, such as connecting the removable nonvolatile storage device 745 to a USB port or other connector of the information handling systems.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
identifying, by the processor, one or more areas of sensitive content in a digital image intended to be sent to a first recipient;
retrieving, by the processor, one or more first rules corresponding to both the intended first recipient and at least one of the one or more areas of sensitive content;
selecting, from a plurality of modification actions, at least one modification action to perform on the digital image based upon at least one of the one or more first rules, wherein each of the plurality of modification actions modifies the digital image differently;
modifying the digital image based upon the at least one selected modification action, wherein the modifying protects at least one of the areas of sensitive content and results in a modified digital image; and
sending, via a computer network, the modified digital image from the information handling system to the intended first recipient.

2. The method of claim 1 further comprising:
identifying one more second rules corresponding to both the sensitive content and an intended second recipient;
determining that the one or more second rules prohibits transmittal of the digital image to the intended second recipient; and
preventing transmission of the digital image to the intended second recipient.

3. The method of claim 1 further comprising:
receiving a request from a user of the information handling system to send the digital image to an intended third recipient;
informing the user of the sensitive content that no third rule exists, corresponding to both the sensitive content and the intended third recipient, to modify the digital image;
receiving a user authorization from the user; and
sending the digital image to the intended third recipient in response to receiving the user authorization.

4. The method of claim 1 further comprising:
prior to the determination that the digital image includes sensitive content:
receiving a reference image in response to displaying a rule creation window to a user;
analyzing the reference image, wherein the analyzing results in reference recognition content; and
storing the reference recognition content in the memory, and
comparing the reference recognition content to the digital image, resulting in the identification of the one or more areas of sensitive content.

5. The method of claim 1 further comprising:
modifying digital image metadata in addition to the modification of the digital image based upon the at least one selected modification action,
wherein the digital image metadata is selected from the group consisting of location data and time data.

6. The method of claim 1 further comprising:
identifying a trust level of the intended first recipient; and
searching a plurality of rules based upon the identified trust level and the sensitive content, wherein the searching results in the identification of the one or more first rules.

7. The method of claim 1 wherein the digital image is created by the information handling system.

8. The method of claim 1 wherein the one or more first rules include one or more of the plurality of modification actions selected from the group consisting of blurring the sensitive content and blacking out the sensitive content.

9. An information handling system comprising:
one or more processors;
a memory coupled to at least one of the processors;
a set of computer program instructions stored in the memory and executed by at least one of the processors in order to perform actions of:
identifying one or more areas of sensitive content in a digital image intended to be sent to a first recipient;
retrieving one or more first rules corresponding to both the intended first recipient and at least one of the one or more areas of sensitive content;
selecting, from a plurality of modification actions, at least one modification action to perform on the digital image based upon at least one of the one or more first rules, wherein each of the plurality of modification actions modifies the digital image differently;
modifying the digital image based upon the at least one selected modification action, wherein the modifying protects at least one of the areas of sensitive content and results in a modified digital image; and
sending, via a computer network, the modified digital image from the information handling system to the intended first recipient.

10. The information handling system of claim 9 wherein the processors perform additional actions comprising:
identifying one more second rules corresponding to both the sensitive content and an intended second recipient;
determining that the one or more second rules prohibits transmittal of the digital image to the intended second recipient; and
preventing transmission of the digital image to the intended second recipient.

11. The information handling system of claim 9 wherein the processors perform additional actions comprising:
receiving a request from a user of the information handling system to send the digital image to an intended third recipient;
informing the user of the sensitive content that no third rule exists, corresponding to both the sensitive content and the intended third recipient, to modify the digital image;
receiving a user authorization from the user; and
sending the digital image to the intended third recipient in response to receiving the user authorization.

12. The information handling system of claim 9 wherein the processors perform additional actions comprising:
prior to the determination that the digital image includes sensitive content:
receiving a reference image in response to displaying a rule creation window to a user;
analyzing the reference image, wherein the analyzing results in reference recognition content; and
storing the reference recognition content in the memory, and
comparing the reference recognition content to the digital image, resulting in the identification of the one or more areas of sensitive content.

13. The information handling system of claim 9 wherein the processors perform additional actions comprising:
modifying digital image metadata in addition to the modification of the digital image based upon the at least one selected modification action, wherein the digital image metadata is selected from the group consisting of location data and time data.

14. The information handling system of claim 9 wherein the processors perform additional actions comprising:
identifying a trust level of the intended first recipient; and
searching a plurality of rules based upon the identified trust level and the sensitive content, wherein the searching results in the identification of the one or more first rules.

15. A computer program product stored in a computer readable storage medium, comprising computer program code that, when executed by an information handling system, causes the information handling system to perform actions comprising:
identifying one or more areas of sensitive content in a digital image intended to be sent to a first recipient;
retrieving one or more first rules corresponding to both the intended first recipient and at least one of the one or more areas of sensitive content;
selecting, from a plurality of modification actions, at least one modification action to perform on the digital image based upon at least one of the one or more first rules, wherein each of the plurality of modification actions modifies the digital image differently;
modifying the digital image based upon the at least one selected modification action, wherein the modifying protects at least one of the areas of sensitive content and results in a modified digital image; and
sending, via a computer network, the modified digital image from the information handling system to the intended first recipient.

16. The computer program product of claim 15 wherein the information handling system performs further actions comprising:
identifying one more second rules corresponding to both the sensitive content and an intended second recipient;
determining that the one or more second rules prohibits transmittal of the digital image to the intended second recipient; and
preventing transmission of the digital image to the intended second recipient.

17. The computer program product of claim 15 wherein the information handling system performs further actions comprising:
receiving a request from a user of the information handling system to send the digital image to an intended third recipient;
informing the user of the sensitive content that no third rule exists, corresponding to both the sensitive content and the intended third recipient, to modify the digital image;
receiving a user authorization from the user; and
sending the digital image to the intended third recipient in response to receiving the user authorization.

18. The computer program product of claim 15 wherein the information handling system performs further actions comprising:
prior to the determination that the digital image includes sensitive content:
receiving a reference image in response to displaying a rule creation window to a user;
analyzing the reference image, wherein the analyzing results in reference recognition content; and
storing the reference recognition content in the memory, and
comparing the reference recognition content to the digital image, resulting in the identification of the one or more areas of sensitive content.

19. The computer program product of claim 15 wherein the information handling system performs further actions comprising:
modifying digital image metadata in addition to the modification of the digital image based upon the at least one selected modification action, wherein the digital image metadata is selected from the group consisting of location data and time data.

20. The computer program product of claim 15 wherein the information handling system performs further actions comprising:
identifying a trust level of the intended first recipient; and
searching a plurality of rules based upon the identified trust level and the sensitive content, wherein the searching results in the identification of the one or more first rules.
